(19) United States
(12) Patent Application Publication
(10) Pub. No.: US 2012/0037807 A1
(43) Pub. Date: Feb. 16, 2012

(54) APPARATUS AND METHOD FOR DETECTING RADIATION EXPOSURE LEVELS

(75) Inventors: Anthony Ujhazy, New South Wales (AU); Jonathan Caldwell Wright, New South Wales (AU)

(73) Assignee: DOSIMETRY & IMAGING PTY LTD., Sydney, NSW (AU)

(21) Appl. No.: 13/138,875

(22) PCT Filed: Apr. 19, 2010
(86) PCT No.: PCT/AU2010/000432

§ 371 Date: Oct. 13, 2011

(51) Int. Cl. G01T 1/20; A62B 17/00; G01J 1/58

(52) U.S. Cl. 250/362; 250/368; 250/361 R; 250/483.1; 2/455

(57) ABSTRACT

Method and apparatus for detection and monitoring of radiation exposure are disclosed, utilising photoexcitable storage phosphors and reading apparatus in a number of configurations for use in homeland security, emergency response and medical fields. In one form, apparatus comprises a portable dosimeter device adapted to receive and multiple phosphor elements to allow population screening in event of mass exposure. Further forms for medical use include insertable probes and adhesive phosphor patches for use in detecting radiation exposure in medical therapy or imaging.

### BACKGROUND OF THE INVENTION

1. Field of the Invention

The present invention relates to apparatus and methods for the detection and monitoring of radiation exposure. In particular, the invention relates to the detection and monitoring of ionising radiation, such as X-ray, γ-ray and UV radiation, by means of photoexcitable storage phosphors.

Aspects of the invention find particular application in homeland security, emergency response and medical fields.

2. Description of the Art

Optically stimulated storage phosphor materials, which form metastable electron hole pairs upon exposure to ionising radiation such as X-rays, are known. Such compounds have found use in imaging plates for medical imaging, which operate by exposing the imaging plate to the radiation to be detected and a subsequent readout step where the plate is exposed to low energy visible or infrared laser (e.g. red) light to cause the latent X-ray energy within the phosphor to be released as emission of higher energy (e.g. blue-green) visible light. This imaging method is called computed radiography, and the visible light emission from the phosphor is then detected and a resultant electric signal converted into digital format for recording and display on a display screen.

With these conventional optically stimulated phosphors, the readout step erases the information stored in the phosphor, for subsequent re-use of the imaging plate.

For use in dosimetry, i.e. measurement of a radiation dose to which a person has been exposed, a person whose employment causes them to be at risk of radiation exposure may carry a dosimetry card or badge incorporating a thermoluminescent or optically stimulated phosphor for recording the radiation dosage exposure. With both the thermoluminescent and optically stimulated phosphors, the information is deleted as the card is read.

WO 2006/063409 (Reisen & Kaczmarek) discloses a different class of storage phosphors based on a rare earth element in a trivalent +3 oxidation state, which reduces to the divalent +2 oxidation state upon exposure to X-ray, γ-ray or UV radiation. A preferred example of such a phosphor is BaFCl:Sm³⁺, which forms a relatively stable Sm²⁺ metal ion trap upon exposure to X-ray, γ-ray or UV radiation.

These photoluminescent storage phosphors differ from the optically stimulated ones in that photoexcitation of the phosphor does not cause reversion of an electron hole pair but instead causes photoluminescence of the phosphor within a narrow band without automatic erasure of the information in the phosphor. Photoexcitation of the photoluminescent phosphor by a relatively high energy (e.g. blue) light will cause a relatively lower energy (e.g. red) emission, as the stored X-ray energy within the phosphor is not released.

WO 2006/063409 states that these stable divalent rare earth (RE²⁺) centres formed upon exposure to radiation provide more narrow luminescence lines and significantly improved contrast ratio than conventional phosphors, and hence may improve sensitivity and facilitate the use of reduced radiation dosages for medical imaging. Furthermore the stored information in the imaging plate is not deleted automatically upon reading, but may be erased deliberately by exposure to light of the appropriate wavelength and intensity, to allow re-use of the imaging plate.

PCT/AU08/001,566 (Riesen), filed 8 Oct. 2008, describes apparatus and method suitable for readout of photoluminescent storage phosphors of the type described in WO 2006/063409, including at least one gating element for gating the excitation light source from the phosphorescent emission from the phosphor.

The contents of WO 2006/063409 and PCT/AU08/001,566 are both incorporated herein by reference.

### SUMMARY OF THE INVENTION

The present invention aims to provide new methods and apparatus for detection and monitoring of radiation exposure, with uses for example in the fields of security, emergency response and medicine.

Various forms of the invention will be apparent from the detailed description below, and from the appended claims.

### BRIEF DESCRIPTION OF THE DRAWINGS

The description is made with reference to the accompanying drawings; of which:

FIG. 1 is a diagram illustrating the “Threat Spectrum” of US homeland security in dealing with terrorist threat, including radiation threats;

FIG. 2 illustrates an example of a personal dosimetry unit and card according to a first embodiment of the invention;

FIG. 3 illustrates an example dosimetry readout device in accordance with a further embodiment;

FIG. 4 illustrates an example dosimetry readout device in accordance with a further embodiment;

FIG. 5 illustrates an example dosimetry readout device in accordance with a further embodiment;

FIG. 6 illustrates an embodiment of a portable dosimetry card;

FIG. 7 illustrates an embodiment of a self-contained dosimetry device incorporating a phosphor card, detector and display;

FIG. 8 illustrates an embodiment of the invention comprising a dosimetry unit and probe adapted for medical use; and

FIG. 9 is a schematic illustration of an example dosage distribution ‘map’ as a result of radiation therapy.

### DETAILED DESCRIPTION OF THE PREFERRED EMBODIMENTS

### Threat Spectrum

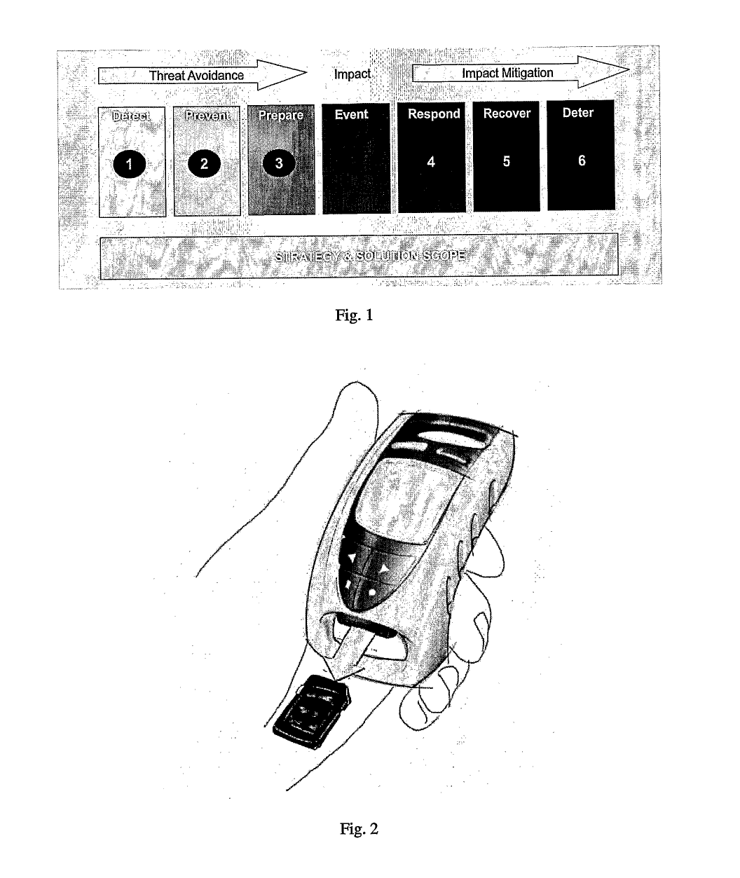

FIG. 1 illustrates the “threat spectrum” strategy for US homeland security for avoidance and mitigation of a terrorism event such as a nuclear radiation threat (source: Deloitte Consulting). Similar strategic thinking is adopted also by other governments.

The spectrum is divided generally into two coarse categories: “threat avoidance” prior to the impact of an event, consisting of detection, prevention and preparation; and “impact mitigation” after the event, consisting of response, recovery and deterrence.

For fit within an overall homeland security strategy, threat response and security measures should relate to one or more of these measures.

### Detector for Transport of Radiative Material

One aspect of the invention relates to an apparatus and method for detection of transport of fission materials such as low grade nuclear material as might be used for a ‘dirty bomb’ nuclear device.

In this embodiment of the invention, a high sensitivity radiation detection system includes one or more phosphor plates containing a photoluminescent phosphor material which does not automatically erase upon reading, and more particularly a phosphor material containing a trivalent 3+ oxidation state rare earth element such as described in WO 2006/063409 and PCT/AU08/001,566.

Rather than the plates consisting of continuous sheets of the phosphor material, the detectors may comprise an array of phosphor dots or similar.

The dosimeter plates or arrays are installed permanently or semi-permanently in position at a transport location such as a port, border crossing, trucking depot or container shipping and transfer facility, or other location where it is desired to detect and prevent the transport of such materials. Preferably the plates are located where the transport vehicles, container or persons pass in close proximity and which cannot readily be bypassed, for example at either side of a roadway lane or gateway or on a surface which the vehicles to pass over or under, or at an airport security or luggage screening location. For example, the detector device may be incorporated in an airport or building metal detector station.

As a person or item carrying radiative material passes by the detector device, the phosphor will react to the emitted radiation from the material by reduction of the rare earth metal to the 2+ state, which can be detected by photoexcitation of the phosphor by a reader and detection of the light emitted by the phosphor, as described in more detail in WO 2006/063409 and PCT/AU08/001,566.

As transported radioactive materials may be of relatively low grade, may be transported in small quantities and may be shielded in attempt to avoid detection, the phosphor grain size and the reader setup are preferably adapted for high sensitivity detection. Especially in regard to the reader, this is facilitated by the permanent or semi-permanent nature of the installation, so that a relatively large and expensive installation may be used, employing a high quality stabilised laser installation for excitation of the phosphor and high accuracy photo detectors for detection of the emitted light, and optionally multiple test sites on the phosphor plate or array.

By using a non-erasing phosphor material, background radiation levels may be more accurately taken into account by taking a baseline measurement before the vehicle or container passes the detector station, and a further measurement immediately afterwards. Also, non-erasure of the phosphor allows additional measurements and data analysis to be undertaken, e.g. multiple readings taken at substantially the same data point to provide further accuracy of detection in relatively low signal to noise ratio conditions.

Furthermore, by use of a non-erasing phosphor material, measurements may be analysed over longer cycles, for example over multiple vehicles, so that any discrepancies from the norm may be recognised and the data cross-checked against other forms of security data, such as video surveillance footage.

### First Responder Personal Dosimetry Monitoring

Further forms of the invention relate to personal dosimetry monitoring for individuals in the event of a radiation event, including for so-called “first responders”—emergency personnel such as police, fire brigade, ambulance and hazardous material (“Hazmat”) teams—and for population screening generally.

One embodiment of the invention relates to a dosimetry apparatus and method for first responders, comprising a portable dosimetry monitor which for example may be adapted to be worn by first responders as part of their uniform.

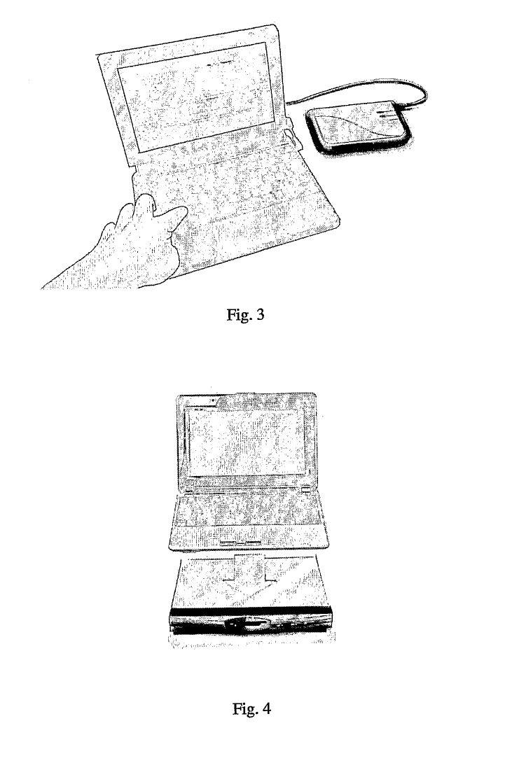

An example of a personal dosimetry monitoring unit and dosimeter card is shown in FIG. 2

The apparatus may include a dosimetry card incorporating a layer of a phosphor based on a 3+ trivalent rare earth element which changes oxidation state upon irradiation by a radiation type to be detected, as previously described and as described in more detail in WO 2006/063409 and PCT/AU08/001,566. The phosphor card is retained in the portable monitoring apparatus which includes a photoexcitation source, and a detector for detecting emission from the phosphor.

The card construction may comprise a suitable material substrate/base layer which provides structural integrity to the card, a phosphor layer and an overcoat layer and/or outer casing provided to protect the phosphor layer against physical damage and accidental exposure.

The personal dosimetry monitor into which the card is incorporated or retained includes control circuitry, software or similar to initiate periodic interrogation of the phosphor, for example between every 1 second and 5 minutes, more preferably between 2 seconds and 1 minute, for example about every 5 to 30 seconds. In one embodiment, photoexcitation of the phosphor is initiated about every 10 seconds.

The cumulative total radiation exposure detected over one or more periods—for example over an hour, a day or a week—is monitored and recorded by the monitor device, and an alarm signal is generated if predetermined threshold levels are reached. The alarm may include a visible and/or audible alarm, for example an alarm sound and/or a flashing LED light. The device may also include a display screen such as an LCD or LED screen which may include a numerical or graphical display showing exposure levels, and one or more user controls such as press buttons.

The device may also have remote communication capabilities, so that alarms may be sent to a remote location, e.g. to a remote station acting as an area or team monitoring station.

The intended use of the portable dosimetry monitoring device is such that it does not require the high sensitivity of the transport detector as described above. For example, a radiation sensitivity of about 1-10 mGy may be sufficient for the portable monitor. This allows the use of smaller, less sophisticated and less expensive photoexcitation and detection devices, for example by use of a pulsed LED of appropriate wavelength for photoexcitation of the phosphor instead of a laser and mechanical gating device.

The device includes a power source, such as a rechargeable battery. The battery may be replaceable for circumstances in an emergency where it is necessary for the first responder to work for a period beyond the life of the battery, or where access to power for recharging the battery is limited.

The dosimetry card may be semi-permanently retained in the monitor device, for example requiring partial dismantling of the device or removal of a removable cover to remove the card for further testing in a more accurate dosimetry monitor, as described in more detail later, or in the event that the personal monitor malfunctions, is damaged, or has a flat battery.

In another embodiment, such as that illustrated in FIG. 2, the phosphor card may be removably insertable in the monitor for example by way of an aperture such as a card slot, which may for example include a spring-driven ejection mechanism or similar to allow easy removal and insertion of the card. This allows not only removal of the card belonging to that personal monitor for testing in a more accurate device, as described above, but also the ability to use the personal monitor to test other compatible phosphor cards, for example for exposure screening of other first responders or general population in the event of a radiation event.

In a further embodiment, a dosimetry device may incorporate dual dosimetry monitors: a personal monitor having a first dosimetry device—such as a first card either permanently, semi-permanently or removably mounted in the monitor—for continually detecting the radiation exposure level of the person to whom the monitoring unit is assigned; and a second removable card mounting and monitoring arrangement which may be used for first pass screening of the dosimetry cards of other persons to allow for initial triage screening for allocation of medical assistance in the event of a radiation incident.

If desired, the dual dosimetry monitors may employ two different size or shape cards. For example the second card mounting may be adapted to receive a smaller card size for general population screening.

The two dosimetry monitors in the device may employ different dosimetry technologies. For example, the personal dosimetry monitor of the device may employ known semiconductor-based dosimetry monitoring technology such as that employed in the available Canberra Industries UltraRadiac Personal Radiation Monitor, while the second monitor in the device may incorporate a slot for a removable phosphor card as described above. When not in use for population screening or the like, the secondary dosimeter card bay may hold a phosphor card which is interrogated periodically to detect the wearer's exposure level, as a backup to the first monitor.

FIG. 3 shows a portable dosimetry readout device, of generally similar capabilities and construction to that of FIG. 2 but adapted for attachment to a computer via a communication cable port or wireless connection. Such devices may find use, for example, in homeland security and military applications as a first pass screening device.

### Dosimetry for Screening/Medical Triage

Significant research effort has been made worldwide in the medical treatment of radiation exposure, with novel and expensive treatments for acute radiation sickness in development.

In the event of a radiation incident with mass population exposure, one of the immediate challenges will be to rapidly determine those people who require immediate intensive treatment, and which people require other levels or priorities of treatment.

In one embodiment of the invention, there are provided forms of dosimetry detectors which are suitable for wide distribution amongst the population and to be carried on the person, so that in the event of a mass population radiation exposure a mass screening or triage may be carried out quickly and efficiently.

Further embodiments of the invention relate to a portable dosimetry reader adapted more accurate readout of dosimetry cards, for example for use in hospitals for routine staff exposure screening or for follow-up triage of patients following a radiation incident, for example after initial coarse categorisation of patients by exposure levels using personal dosimeter units as described above.

An example of a dosimetry reader of one embodiment of the invention is illustrated in FIG. 4.

The dosimetry readout unit of FIG. 4 incorporates a cabinet shell which contains one or more card slots for receiving dosimetry card to be read, a dosimetry monitoring apparatus, and power and control circuitry.

As seen in FIG. 4, the unit cabinet has a height and depth of similar size to the footprint of a laptop computer, for example approximately 15-30 cm deep by 20-40 cm wide, so that in use it forms a base on which the laptop computer sits. The unit has one or more communication means for communicating with the laptop, for example by USB port, wifi, bluetooth or other suitable wired or wireless communications standard, so that the computer may be used as the user interface and display for the unit.

At the front of the cabinet is a slot for receiving a dosimetry card to be interrogated, and optionally a set of basic controls such as power button and card eject button, and status indicators.

The card slot may be adapted to receive dosimetry cards of a plurality of several different sizes or types, or optionally multiple slots may be provided.

The detecting and monitoring componentry of the unit is preferably of high sensitivity, for example of a resolution of measurement range from 100 nGy to 100 Gy, or optionally from 1 mGy to 1 Gy at a resolution of about 100 nGy to 1 mGy. The apparatus shown and described in FIGS. 2 and 15 of PCT/AU2008/001566—incorporating a pulsed laser or LED light source, first gating element, lenses and beam splitter, light detector and second gating element—is one preferred form.

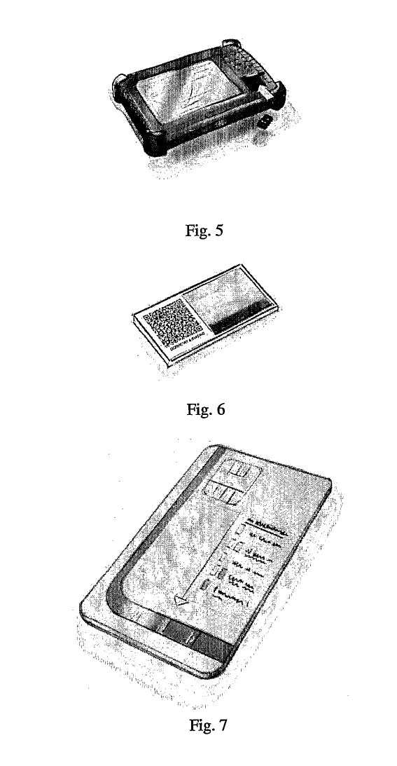

FIG. 5 shows a further embodiment of the device, which is adapted for use as a stand alone device with its own display screen and controls, and so does not require connection to a laptop or other computer for its operation. The unit of FIG. 5 is preferably of a ruggedised construction to withstand impacts and adverse environments without malfunction, for example by the use of a heavy duty cabinet, corner impact protection, and other ruggedisation measures known per se in relation to the construction of ruggedised portable computers for use in mining and military applications.

It can be seen from FIG. 5 that the unit of this embodiment is adapted for use with a small size dosimetry card, about the size of a mini- or micro-SD card, for example approximately 5 to 30 mm in its major dimensions. This card is adapted to be inserted into the unit via an aperture formed behind a movable or removable cover of the device.

The preferred detection and monitoring technology of the device is as described above, and as described and shown in PCT/AU2008/001566.

FIG. 6 shows one form of dosimetry card which may be issued to first responder personnel, workers or to the general population at a location at risk of a radiation incident, and/or carried as a backup device by first responders such as member of a Hazmat team.

The card may include a substrate, phosphor layer and protective layer or casing as previously described.

The surface of the card may include a barcode area, for example a 2-dimensional barcode according to the universal standard, which is particular to that card. The device may incorporate a barcode reader so that the card can be identified and correlated to ownership and other relevant information including the issue date to allow an estimation to be made of accumulated background and incidental radiation such as medical imaging or radiation treatment, which information may be held on a remote database.

In addition to acting as identifying information for the dosimetry card, the barcode may also act as a locator which is in known physical relationship to an area of the phosphor on the card to be tested. This facilitates the use of the device with different sizes or types of cards, as the location of the barcode will tell the device what area of the card is to be tested.

Instead of, or in addition to, use of the barcode as a locator device, the card may employ other locator means, such as other markings on the card, or physical formations on the card such as slots or cut-outs, which assist the device to locate the area to be tested.

The dosimetry card of FIG. 6 may take other physical forms, and in particular may include a flexible base substrate having an adhesive layer allowing the card to be adhered to what is known in the homeland security field as a “common domestic platform”, i.e. a portable article that the user would typically carry on their person in their everyday activities, such as driver's license or healthcare or identity card, a watch, or a medical alert bracelet. In one embodiment, the card may be formed as a flexible, self-adhesive strip which may be attached to a personal consumer item, for example to the rear of or inside a battery compartment cover of a mobile phone.

If desired, the phosphor layer may be formed on a less flexible portion of the card which is secured in position by being incorporated within the flexible adhesive strip.

The flexible strip card may include printing, for example barcode and/or locator markings as discussed above.

In a further embodiment, the phosphor may be included as an internal layer within a card such as a driver's license or identity card, which is adapted to be punched to remove a small core sample through the card, for example of 1 mm to 5 mm diameter. The punched sample will thus expose the phosphor layer at the edge of the sample, which can be read by similar technology to that previously described.

The punch tool for removing the sample from the card may be incorporated in the dosimeter reader apparatus, for example including a punch and a receptacle/sample holder for receiving the punched sample for testing. The punching apparatus may also provide a scraper or similar for scraping the edge of the sample to present a clean edge for reading of the phosphor.

The thickness of the phosphor layer within the card is preferably sufficient for the punched sample to contain at least about 0.1 mg of the phosphor, preferably from 0.1 to 10 mg, and preferably from about 1 to 5 mg.

The phosphor may be contained within the card in a single layer of a dimension sufficient to allow the punching of multiple samples, or alternatively the phosphor may be present in multiple specific regions of the card. The card and phosphor characteristics in these regions may be similar or different. For example, similar regions will allow taking of multiple samples over time for comparison, or having the card incorporate different attenuating or energy compensating materials adjacent the phosphor in each region may allow better identification of the type of radiation to which the card bearer has been exposed.

A further embodiment of the invention relates to a self-indicating personal dosimetry device which incorporates a phosphor card, detector and a display which indicates the radiation exposure level to which the device has been exposed.

A form of this device is illustrated in FIG. 7, which shows a dosimetry device incorporated into a generally rectangular card shape approximately the height and width of a credit card and about two to three times the thickness, to be carried on the person—for example in the wallets—of the general population in an at-risk location or as a backup device for first responder personnel such as Hazmat team members.

The device includes a phosphor as previously described, monitoring and measurement apparatus for reading the radiation exposure detected by the phosphor, and a simple electronic display of the exposure level, which may be in the form of green, orange and red LED lights to indicate the danger level. By operation of two of the LEDs at once, the display is able to indicate five exposure levels: green, green and orange, orange, orange and red, and red.

The device includes a power source such as a replaceable or built-in battery.

The card may be formed for example using a printed circuit board (PCB) or surface mounted component circuit board construction, a hybrid of PCB and surface mount construction, or a hybrid substrate including the solid state devices and the phosphor.

The card may incorporate written material on its surface with instructions as to the appropriate response to each of these levels.

Again, this device is intended for use as a coarse exposure indication rather than a fine measurement, and so requires only a sensitivity of approximately 10-100 mGy resolution, more preferably 10-50 mGy, a less sophisticated readout apparatus such as a pulsed LED for photoexcitation of the phosphor.

In the event of battery failure or malfunction, the phosphor element of the card may be able to be removed for reading in one of the card monitoring units described in relation to FIGS. 2 to 5.

The various forms of the invention may thus provide a suite of different dosimetry cards and readers based on a common technological platform such that the cards are readable by a number of different devices of varying sensitivity and cost, from self-indicating devices and relatively inexpensive first responder and first-pass screening readers in the event of a mass radiation exposure to more sensitive readers for follow-up triage for allocation of medical treatment.

### Detection and Monitoring of Radiation Dosage in Medical Therapy

A further form of the invention relates to medical applications of dosimetry, to medical and dental imaging, and in preferred forms to applications of the invention to dosage detection and regulation in radiation therapy for cancer treatment and the like.

One form of cancer treatment used for curative or palliative treatment is radiation therapy, in which ionising radiation beams such as photon beams from a linear accelerator are directed to the specific site of the cancer to destroy the cancerous cells. The beams may be directed from outside the patient's body (external beam radiotherapy) or internally via placement of the radiation source at the tumour site (brachytherapy).

In order to reduce side effects and damage to skin and adjacent healthy tissue, and to increase the capacity of the patient to withstand the overall effects of the therapy, the total radiation dosage is usually split into smaller doses delivered over time, both within a single radiation therapy session and over multiple sessions over days or weeks.

In radiation therapy, the total radiation dosage, the break-up of that dosage into individual doses and the accuracy of positioning of the radiation beam at the site of the cancer are important to the success of the therapy and in minimising side effects from the therapy.

One aspect of the invention aims to provide apparatus and method which assist in achieving better clinical outcomes for the patient.

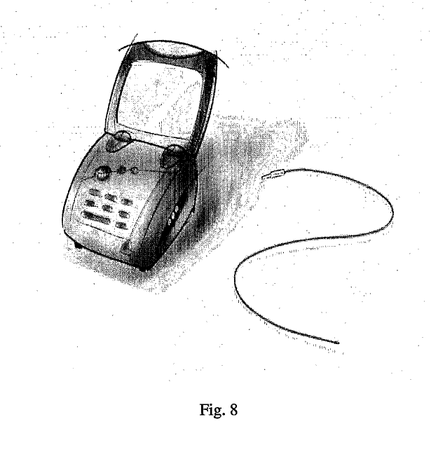

In one embodiment of the invention, an example of which is shown in FIG. 8, there is provided a radiation detection probe for use in detecting radiation applied to a patient in radiation therapy. The probe comprises a radiation detection phosphor element at a portion of the probe, and a probe body having a hollow lumen with guide wires or other means for guiding the phosphor element to a desired location, for example adjacent to a tumour to be treated.

The probe further includes one or more optical transmission elements, for example optical fibres, which allow remote readout of the phosphor by directing a phosphor photoexcitement source such as an LED or laser source of the appropriate wavelength onto the phosphor, and for directing light emitted by the phosphor to a reading device located externally of the patient's body.

The phosphor element is located at a remote end of the probe and preferably comprises a phosphor of the type which does not erase upon readout, most preferably a phosphor including a trivalent 3+ rare earth element as described above and in WO 2006/063409 and PCT/AU08/001,566.

A plurality of phosphor elements may be provided in a spaced array, for example over a 1-2 cm length of the probe. The phosphor elements may each be provided with a separate optical fibre and readout mechanism, and thus be able to provide information about both the total and distribution of the radiation intensity profile of the treatment beam in the vicinity of the probe, or else may share a common readout and be adapted to provide just a total value for the radiation.

In one embodiment, the phosphor elements may each comprise a micro-dot of the phosphor material attached to the end of a respective optical fibre.

The probe body is elongated and flexible, and may include a guidance mechanism for guiding the probe into the desired position, for example a hollow lumen catheter having a guide wire mechanism of the type known per se and well known in respect of surgical probes and remote surgery implements.

The probe may be adapted for insertion into the body via a body orifice, e.g. oral, nasal or rectal, or may be adapted for percutaneous insertion and access via the vascular system or direct through the patient's tissue to the site.

At the other end of the probe, i.e. the distal end, is an optical connection and optionally other connections for connecting the probe to a detection and readout unit as shown in FIG. 8. Preferably, the connection between the probe and the detection unit is located outside the sterile field surrounding the patient, so that only the probe need be sterile.

The unit incorporates a detection unit for interrogation and readout of the radiation exposure level detected by the phosphor element, incorporating for example the readout technology described above and in WO 2006/063409 and PCT/AU08/001,566 except that instead of the blue LED or laser source being directed onto the phosphor card within the device it is directed down the probe via the optical fibre to the phosphor, which becomes photoexcited and emits light as discussed above.

The light emitted by the phosphor travels back along an optic fibre in the probe to the detector unit, where the emission spectra is detected and analysed to determine the radiation dosage received at the probe location.

Separate optic fibres may be used for the photoexcitation source and the phosphor emission back to the unit, or alternatively a single fibre may be shared with use of beam splitter built into the detection unit or interposed between the unit and the probe.

In operation, the probe may be positioned in or on the patient prior to commencement of the radiation therapy session so that the phosphor element of the probe is at a desired location, usually directly adjacent the tumour to be irradiated so that the dosage received by the tumour can be determined. Alternatively, the probe can be positioned near healthy tissue adjacent the tumour, to give a reading of what dosage is being received by the healthy tissue.

The detected radiation dosage reading may then be used in either detect and display or detect and control modalities for setting dosage for subsequent radiation doses.

If detect and display mode is used, the detection unit may be set to display the detected radiation dosage to the clinician and other pertinent information such as a cumulative dosage and a comparison against the scheduled radiation dosage regimen. The unit may also be set to display or sound an alarm signal when the detected dosage is outside certain predefined parameters. The clinician may then adjust the dosages for subsequent doses based on the information displayed and his/her judgement.

If detect and control mode is used, the detected dosage information from the unit is communicated back to the radiation therapy device for comparison against the pre-programmed dosage regimen and adjustment of the radiation dosages generated by the machine for future doses if necessary.

In a further embodiment, the probe may comprise a phosphor patch for attachment to the patient's skin, for example by adhesive, which includes at least one phosphor element and a fibre optic connection back to the detection unit. These phosphor patches may find application for example in detecting incident radiation exposure during radiotherapy, as described above, or for detecting radiation exposure medical imaging. In the latter application, individual dot patches may be applied at one or more locations in the outer region of the imaging field, so as to provide a measurement of the radiation dose without shadowing of the target area for imaging.

The patch may include a plurality of phosphor areas such as dots, each linked back to the unit via a dedicated optical fibre for monitoring of radiation exposure over a larger skin area. Alternatively, a plurality of discrete patches may be used.

The phosphor patch may be based generally on the flexible strip phosphor patch construction previously described, and may incorporate barcodes or other indicia as described above. In addition, the patch may include location markings for assisting with relative positioning of the patient and the machine to ensure accuracy of the treatment.

In a further form, a larger area phosphor patch may be provided which is adapted for attachment to the patient's skin, for example including a flexible sheet base substrate for the phosphor and an adhesive, and is removable after the radiation treatment for interrogation and readout by a remotely located readout device. Such a device may be of generally similar construction and operation to the other reader devices described herein, or in one form may include a device which is incorporated into a shroud which is placed over the patch for shielding ambient light.

The phosphor may be incorporated in the patch as a continuous layer, or as an array of discrete dots or the like.

A similar shroud-mounted device may also be used for reading of any of the other dosimeter cards described in this patent specification, optionally using the locator markings or formations on the card for maintaining alignment of the card and the reader.

Alternatively, the patch may be read in situ. Again, the patch may include markings such as barcode and location markings for assisting the clinician.

For in situ reading of the patch, the reader may be constructed with a portable scanning head attached via cable to the body of the reader, for example generally similar in configuration to a portable bar code scanner.

In one embodiment of an in situ reader apparatus, the patch scanning head may include a shroud which is placed over the patch by the operator, and includes an annular portion. The diameter of the annular portion is preferably greater than or substantially equal to that of the patch, so that the shroud fits over the patch and substantially excludes light from entering the shroud.

The scanning head may also include locating means which co-operates with marking on the patch to assist the operator with proper alignment and positioning of the scanning head. For example, the patch may include a marking around its periphery which is detected by a sensor in the shroud, with the scanning head having an LED or similar which indicates when the head is in proper position, for example by the LED changing colour from red to green.

Alternatively, the scanning head may include a micro-mechanical mirror system or other adjustment mechanism for fine adjustment of the optics so that the phosphor may be read despite minor misalignment of the scanning head relative to the patch.

In one embodiment, the phosphor patch may comprise a phosphor sheet adapted to be attached to the patient's skin between the radiation source and the tumour site, thus providing a dosage ‘map’ of where the radiation has entered the patient's body. This is distinct from traditional medical imaging, where the image is of the radiation which has passed through the body.

In one embodiment, the reading of the phosphor patch may be of relatively low resolution, allowing the employment of less expensive detection technology, such as a source of evenly distributed stimulation of the phosphor patch and a charge-coupled device (CCD) camera as the reader. In some embodiments, the CCD camera used may be of relatively low resolution, for example as low as 0.5 megapixel resolution.

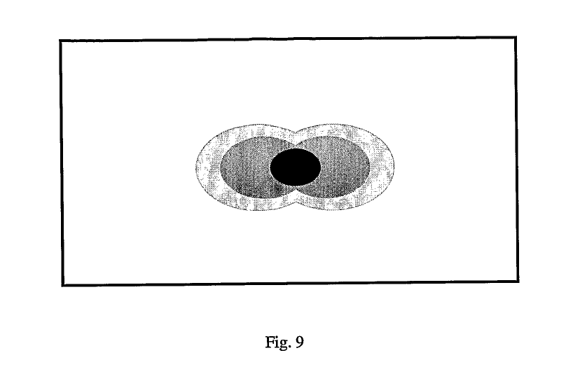

The information received by the detector may then be processed to provide a dosage map in which the distribution and/or dosage of the incident radiation is depicted in graphical form, for example as zones in which different ranges of radiation dosage are depicted by different colours, or in which the colour intensity is graded to be representative of the dosage detected. A schematic example of such a display is shown at FIG. 9, which shows a rectangular patch in which the darker coloured zones represent zones of higher radiation exposure. The darkest zone represents the narrow therapeutic radiation zone, while the lighter zones represent regions of incidental radiation exposure.

Alternatively, where the phosphor sheet contains a number of discrete phosphor dot areas, the readout ‘map’ may be formed as an array of point readings.

### Occupational Clothing Incorporating Dosimetry Phosphor Elements

A further form of the invention relates to occupational clothing for persons at risk of radiation exposure, for example in uniforms issued to military personnel or to emergency services personnel or other ‘first responders’, or for hospital or other health care personnel at risk of exposure, and to methods of monitoring radiation exposure of such persons by incorporating phosphor elements in their issued clothing.

In one embodiment, phosphor material such as that previously described is incorporated into the personnel's uniform, for example as phosphor elements at defined locations within the fabric of the uniform. The phosphor elements may for example comprise the phosphor suspended or otherwise incorporated in a polymer material and formed into thread for inclusion in the fabric of the uniform at specified locations. For example the phosphor-containing threads may be woven into the fabric or threaded along seams or stripes of the uniform, to allow removal and testing following suspected radiation exposure, or for regular routine testing.

The polymer material in which the phosphor is suspended should be non- or low-fluorescent under the light source used for reading the phosphor.

In one embodiment, the thread may comprise a hollow tube for example of nylon material, containing phosphor beads comprising the phosphor material suspended or encapsulated in an optical grade material, for example optical grade epoxy. Following a suspected radiation event, or periodically, the hollow thread may be cut and the phosphor beads removed for reading.

The locations of the uniform at which the phosphor material is included may correspond to areas of the body most sensitive to radiation exposure, for example the lungs or kidneys, and the threads may be colour-coded or otherwise labelled to identify the region of the body to which they relate, so that the pattern and severity of the wearer's radiation exposure can be ascertained.

As an alternative to including the phosphor into the thread, micro-dots or beads of the phosphor similar to those previously described may be incorporated into the uniform at predetermined locations.

In one embodiment, where it is wished to detect exposure to high energy, high dose radiation exposure, for example as might be encountered by certain military personnel, the phosphor elements in the uniform may further include an adjacent material which interacts with the radiation to increase detection, such as a barium-loaded polymer or other suitable material for adjusting dmax. This dmax modifier material may be incorporated for example as a sheath surrounding the phosphor thread, or a layer on the micro-dots, which is removed before reading the phosphor.

In an alternative form of the invention, the phosphor material may be incorporated in a substrate and encapsulation in a biocompatible optical grade material suitable for direct implantable under the skin (but not deeply within the body tissue and not the muscle tissue) of military personnel or other at-risk persons. Implantation would be typically in a region of the body that would be readily locates and be least irritating to the person, and in particular least prone to mechanical shock or pressure, for example the inside of the arm above the elbow.

In one form, the implant is adapted for removal either at regular intervals or following a suspected radiation exposure incident for reading of the radiation that the person has been exposed to.

In an alternative form, the implant is accessible to a reader probe containing an optical fibre, for example generally similar to that described above in relation to medical therapy Dosimetry. The implant reader probe may be in the form of a hollow lumen catheter having at a proximal end a hollow needle to pierce the skin in order to make physical contact with the implanted dosimeter. The optic fibre from the reader is contained within the hollow needle and would be contact the implant to take a reading. Optionally, the catheter is an irrigated catheter, to wash the contact surface between the end of the optical fibre and the implant.

The needle probe would also have a tissue depth gauge and this data would be used to calculate energy build-up caused by the layer of tissue over the implant.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all changes which come within the meaning and range of equivalency are therefore intended to be embraced therein. It will further be understood that any reference herein to known prior art does not, unless the contrary indication appears, constitute an admission that such prior art is commonly known by those skilled in the art to which the invention relates.

1. A radiation dosimetry probe for use in detecting radiation exposure to a patient in radiation therapy, comprising a radiation detection phosphor at a portion of the probe, and a probe body having means for guiding the phosphor to a desired location.

2. A radiation dosimetry probe according to claim 1, further comprising at least one light transmission element for transmission of light between the phosphor and a remote end of the probe.

3. A radiation dosimetry probe according to claim 2, having a first said light transmission element for transmitting light from a photoexcitation light source to the phosphor and a second said light transmission element for transmitting light emitted by the phosphor to a detector.

4. A radiation dosimetry probe according to claim 2, wherein a first said light transmission element transmits light from a photoexcitation light source to the phosphor and transmits light emitted by the phosphor to a detector.

5. A radiation dosimetry probe according to claim 2, wherein said light transmission element is an optic fibre.

6. A radiation dosimetry probe according to claim 2, said probe further comprising a connector for connection of the probe to a radiation dosimetry monitoring apparatus.

7. A radiation dosimetry probe according to claim 1, wherein said phosphor is a photoexcitable storage phosphor of a type which does not erase upon readout.

8. A radiation dosimetry probe according to claim 7 wherein said phosphor comprises at least one rare earth element in the trivalent +3 oxidation state and wherein upon radiation by X-ray, γ-ray or UV radiation the trivalent +3 oxidation state is reduced to divalent +2 oxidation state.

9. A radiation dosimetry probe according to claim 8, wherein said rare earth element is samarium.

10. A radiation dosimetry monitor for use in detecting radiation exposure to a patient in radiation therapy, comprising a readout device adapted to communicate with a probe according to claim 1 and a display for displaying a radiation exposure level of said phosphor.

11. A radiation dosimetry monitoring apparatus for use in detecting radiation exposure to a patient in radiation therapy, comprising a radiation dosimetry probe according to claim 1.

12. A radiation dosimetry patch including a substrate adapted for adhesion to the skin of a patient undergoing radiation therapy, and a phosphor supported by said substrate which changes oxidation state upon exposure to radiation.

13. A radiation dosimetry patch according to claim 12, wherein said substrate is flexible.

14. A radiation dosimetry patch according to claim 12, wherein said patch includes one or more locator markings.

15. A radiation dosimetry patch according to claim 11, wherein said patch includes one or more barcode markings.

16. A radiation dosimetry patch according to claim 11, wherein said phosphor is adapted to change oxidation state in response to incident radiation of the radiation therapy, to record the incident radiation dosage of said therapy.

17. A radiation dosimetry patch according to claim 16, wherein said phosphor records distribution of the incident radiation dosage of said therapy.

18. A method of monitoring radiation exposure during radiation therapy of a patient, comprising providing a radiation dosimetry probe comprising a radiation detection phosphor at a portion of the probe and a probe body having means for guiding the phosphor, guiding said probe so as to locate said phosphor in proximity to a radiation therapy site of said patient, and interrogating said phosphor by stimulation of said phosphor and detection of a phosphor response.

19. A method according to claim 18, including providing multiple phosphor elements on said probe and interrogating said multiple phosphor elements so as to monitor radiation distribution of said therapy.

20. A method of monitoring radiation exposure during radiation therapy of a patient, comprising attaching at least one phosphor patch to the patient's skin at a position at a radiation inlet side of the patient, said phosphor patch comprising a substrate and a phosphor supported by said substrate which changes oxidation state upon exposure to radiation, and interrogating said phosphor of the phosphor patch by stimulation of said phosphor and detection of a phosphor response.

21. A method according to claim 20 wherein said at least one phosphor patch comprises a multiple phosphor locations, and wherein said interrogating comprises interrogating said multiple phosphor locations to detect a distribution of radiation exposure.

22. A method according to claim 21 wherein said at multiple phosphor locations are formed by discrete phosphor regions.

23. A method according to claim 21 wherein said at multiple phosphor locations are within a single phosphor region.

24. A method according to claim 21 wherein said interrogating comprises simultaneous stimulation of said multiple phosphor locations and capturing an image of said phosphor response of said multiple phosphor locations.

25. A method according to claim 22 wherein said interrogation comprises separately interrogating said multiple phosphor regions by means of a movable interrogation head.

26. A method according to claim 22 wherein said movable interrogation head includes an indicator for indicating a desired location of the interrogation head relative to a phosphor region.

27. A personal radiation dosimetry monitor comprising a phosphor which changes state upon exposure to a radiation, a readout device for interrogating the phosphor to detect a radiation level to which the phosphor has been exposed, and a display for indicating the detected radiation exposure level.

28. A personal radiation dosimetry monitor according to claim 27 wherein the phosphor is a photoluminescent phosphor.

29. A personal radiation dosimetry monitor according to claim 27 wherein the phosphor is on a phosphor element which is removably and replaceably received by the readout device.

30. A personal radiation dosimetry monitor according to claim 29 wherein the phosphor element may be removed and replaced with a similar phosphor element for detection of the radiation exposure level of the similar phosphor element.

31. A personal radiation dosimetry device according to claim 27 wherein the device includes dual radiation exposure detection devices.

32. A personal radiation dosimetry device according to claim 31 wherein the dual radiation detection devices include a first radiation exposure detection device comprising said phosphor and readout device, and a second radiation exposure detection device.

33. A personal radiation dosimetry device according to claim 32 wherein the second radiation exposure detection device comprising a further phosphor element and readout device for said further phosphor element.

34. A personal radiation dosimetry device according to claim 31 wherein the dual radiation detection devices include a first radiation exposure detection device for detecting the radiation exposure level of a person wearing said monitor, and a second radiation exposure detection device adapted to receive and test phosphor elements of other persons.

35. A method of screening for radiation exposure, including:
issuing of personal radiation storage phosphor devices to members of a population to be screened for radiation exposure;
issuing to a wider range of emergency response personnel of first readout devices capable of interrogating the phosphor devices to detect a radiation exposure level to which the phosphor device has been exposed, said readout being capable of detecting the radiation exposure level to a first sensitivity or resolution;
testing the phosphor devices of a portion of the population using said first readout devices and dividing the tested population according to results of the detected radiation exposure levels;
issuing to a more narrow range of emergency response personnel of second readout devices capable of interrogating the phosphor devices to detect a radiation exposure level to which the phosphor device has been exposed, said readout being capable of detecting the radiation exposure level to a second sensitivity or resolution which is higher than the first sensitivity or resolution; and
testing the phosphor devices of a sub-portion of the population using said second readout devices, said sub-portion of the population having been divided from the tested population by said results from the test using the first readout devices.

36. A method for screening for occupational radiation exposure of at-risk persons, comprising:
issuing to said persons clothing having one or more radiation storage phosphor elements; and
screening said radiation storage phosphor elements to detect for radiation exposure.

37. A method according to claim 36 wherein said one or more radiation storage phosphor elements comprise threads incorporated in said clothing.

38. A method according to claim 36 wherein said radiation phosphor elements are located at predetermined positions of said clothing and each radiation phosphor element is marked to indicate a position of said element on said clothing.

39. A method according to claim 38 wherein said radiation phosphor elements are colour-coded to indicate said positions.

40. An item of occupational clothing incorporating one or more radiation phosphor elements.
